(19) United States
(12) Patent Application Publication
(10) Pub. No.: US 2009/0311400 A1
(43) Pub. Date: Dec. 17, 2009

(54) FOOD RACK

(76) Inventor: Neil Andrew Allen, Western Australia (AU)

Correspondence Address: NIXON & VANDERHYE, PC, 901 NORTH GLEBE ROAD, 11TH FLOOR, ARLINGTON, VA, 22203, US

(21) Appl. No.: 12/375,938

(22) PCT Filed: Jul. 31, 2007
(86) PCT No.: PCT/AU07/01055

§ 371 Date: Jan. 31, 2009

(30) Foreign Application Priority Data
Aug. 1, 2006 (AU) 2006904138

(51) Int. Cl. A47J 37/04; A47J 37/00; A23L 1/01

(52) U.S. Cl. 426/523; 99/419; 99/448

(57) ABSTRACT

A food rack including a frame having a plurality of food supporting members mounted rotatably within the frame. At least one end of the food supporting members are detachable from the frame to allow the food supporting members to be passed through the food items. When food items are supported on the food supporting members and the frame is placed over a cooking surface, each of the food items contacts the cooking surface and movement of the frame parallel to the cooking surface causes rotation of the food supporting members.

### FIELD OF THE INVENTION

The present invention relates to a food rack for holding food during cooking.

### BACKGROUND TO THE INVENTION

It is common when frying food either on a pan, barbeque or similar device to need to tend to a number of food items at one time. For example, when cooking sausages it is usual for a number of sausages to be cooked simultaneously. In order to ensure even cooking of the sausages, they must be regularly turned which requires each sausage to be turned individually. Further issues arise, particularly on a barbeque in which the plate is generally angled or curved to allow oil to drain, in trying to keep the sausages in place.

The present invention attempts to overcome at least in part the aforementioned problems of simultaneous preparation of a number of food items.

### SUMMARY OF THE INVENTION

In accordance with one aspect of the present invention there is provided a food rack comprising:

a frame having a plurality of food supporting members mounted rotatably within the frame, at least one end of the food supporting members being detachable from the frame to allow the food supporting members to be passed through the food items;
wherein when food items are supported on the food supporting members and the frame is placed over a cooking surface, each of the food items contacts the cooking surface and movement of the frame parallel to the cooking surface causes rotation of the food supporting members.

Preferably the frame includes first and second side members and the food supporting members comprise a plurality of parallel skewers extending between first and second side members adjacent lower edges thereof, the lower edges being the part of the food rack closest to the cooking surface in use.

Preferably the frame includes a handle extending both away from the frame and the lower edges of the first and second side members.

Preferably the frame is provided with a securing member moveable between a closed position in which the securing member prevents movement of the food supporting members away from the frame and an open position in which at least an end of the food supporting member is detachable from the frame.

The securing member may be pivotally secured adjacent an end of the first and second side members such that the securing member is pivotable between the open and closed positions thereof.

In one embodiment, the first and second side members may include slots extending upwardly from the lower edges thereof into which are received the ends of the food supporting members and the securing member comprises a U-shaped member pivotable such that sides of the U-shaped member close across the slots to retain the food supporting members in the slots.

In a further embodiment, the first side member includes slots extending upwardly from the lower edge thereof for receiving ends of the food supporting members, the second side member includes a plurality of holes adjacent the lower edge thereof for receiving ends of the food supporting members and the securing member comprises a member pivotable such that securing member closes across the slots in the first side member to retain the food supporting members.

Advantageously, the securing member may be provided with a lever wherein actuation of the lever moves the securing member from the closed to the open position. The lever may be located adjacent the handle such that gripping the handle and lever together moves the securing member to the open position.

In a preferred embodiment, the first and second side members are joined by first and second end members, the first end member extending between first ends of the first and second side members and the second end member extending between second ends of the first and second side members. The first and second side members and the first and second end members may each comprise an elongate plate member oriented in a vertical plane.

In one embodiment, the lengths of the first and second end members are adjustable such that the first and second side members may be moved either toward each other or away from each other to accommodate different sized food items.

In another embodiment, each of the first and second side members includes holes to receive the food supporting members and the first end member comprises first and second parts pivotally connected such that pivoting of the first and second parts causes the second ends of the first and second side members to move away from each other, thereby allowing the food supporting members to disengage from the holes.

In a further embodiment, the first end member comprises first and second parts pivotally connected such that pivoting of the first and second parts relative to each other allows the first end member to be moved to a position on top of the second side member for storage.

Preferable the handle is detachable from the frame.

The first and second side members may comprise elongate rod members having a first set of V-shaped bends extending upwardly from the lower edge in which are received the food supporting members. Further, the first and second side members may be provided with corrugations on an upper edge thereof for receiving a second set of food supporting members for cooking food items that do not require to be in contact with the cooking surface.

Throughout the specification, unless the context requires otherwise, the word “comprise” or variations such as “comprises” or “comprising”, will be understood to imply the inclusion of a stated integer or group of integers but not the exclusion of any other integer or group of integers. Likewise the word “preferably” or variations such as “preferred”, will be understood to imply that a stated integer or group of integers is desirable but not essential to the working of the invention.

### BRIEF DESCRIPTION OF THE DRAWINGS

The present invention will now be described, by way of example, with reference to the accompanying drawings, in which:

FIG. 1a is an upper perspective view of a first embodiment of a food rack in accordance with the present invention;

FIG. 1b is a lower perspective view of the food rack of FIG. 1a in which the securing means is disengaged from the food supporting members;

FIG. 2 is an upper perspective view of the food rack of FIG. 1 on a fry pan;

FIG. 3a is an upper perspective view of a second embodiment of a food rack in accordance with the present invention;

FIG. 3b is a lower perspective view of the food rack of FIG. 3a in which the securing means is disengaged from the food supporting members;

FIG. 4a is an upper perspective view of a third embodiment of a food rack in accordance with the present invention;

FIG. 4b is an upper perspective view of the food rack of FIG. 4a in which the frame has been expanded;

FIG. 4c is an upper perspective view of the food rack of FIG. 4a in which the handle has been removed;

FIG. 5a is an upper perspective view of a fourth embodiment of a food rack in accordance with the present invention;

FIG. 5b is an upper perspective view of the food rack of FIG. 5a in which the frame has been collapsed;

FIG. 5c is an upper perspective view of the food rack of FIG. 5a with sausages mounted on the food supporting members;

FIG. 5d is a side view of the food rack of FIG. 5c;

FIG. 6a is an upper perspective view of a fifth embodiment of a food rack in accordance with the present invention;

FIG. 6b is an upper perspective view of the food rack of FIG. 6a in which the frame has been expanded;

FIG. 7a is an upper perspective view of a sixth embodiment of a food rack in accordance with the present invention, in which the handle is provided as a separate element;

FIG. 7b is an upper perspective of the food rack of FIG. 7a in which the handle is separated from the frame;

FIG. 8a is an upper perspective view of a seventh embodiment of a food rack in accordance with the present invention;

FIG. 8b is an upper perspective view the food rack of FIG. 8a with the securing means released;

FIG. 9a is an upper perspective view of an eighth embodiment of a food rack in accordance with the present invention;

FIG. 9b is an upper perspective view the food rack of FIG. 9a with the securing means released;

FIG. 10a is an upper perspective view of a ninth embodiment of a food rack in accordance with the present invention; and

FIG. 10b is an upper perspective view the food rack of FIG. 10a with the securing means released.

### DESCRIPTION OF THE PREFERRED EMBODIMENTS

Referring to the Figures, there is shown a food rack 10 comprising a frame 12 and a plurality of food supporting members 14. The frame 12 in the embodiments shown comprises a rectangular frame having first and second opposed sides 16 and 18 and first and second opposed ends 20 and 22. Each of the first and second sides 16 and 18 and first and second ends 20 and 22 consist of an elongate plate member connected such that when the frame 12 is placed on a cooking surface, each of the plate members is oriented in a vertical plane.

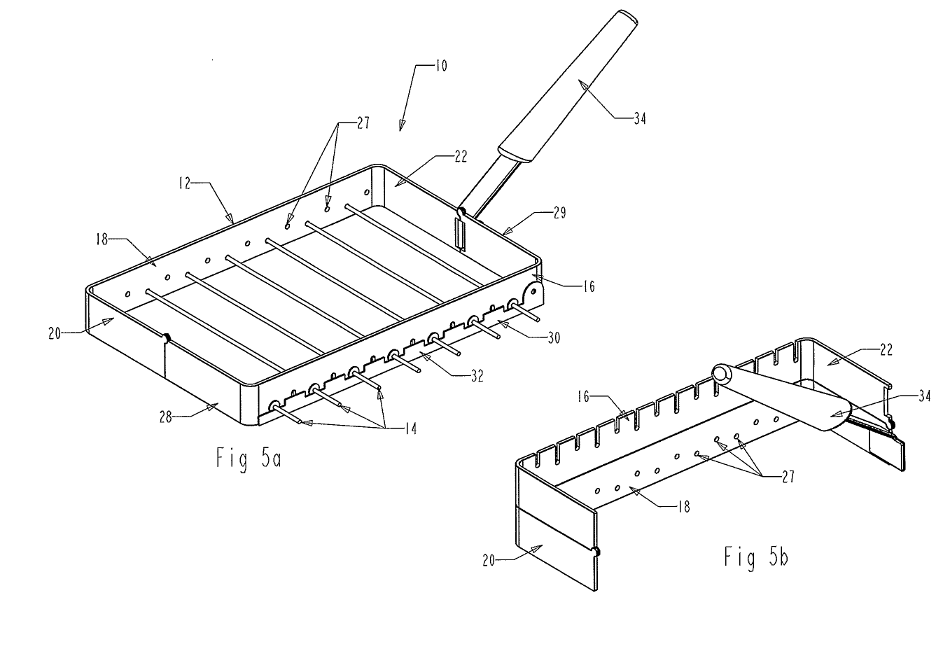

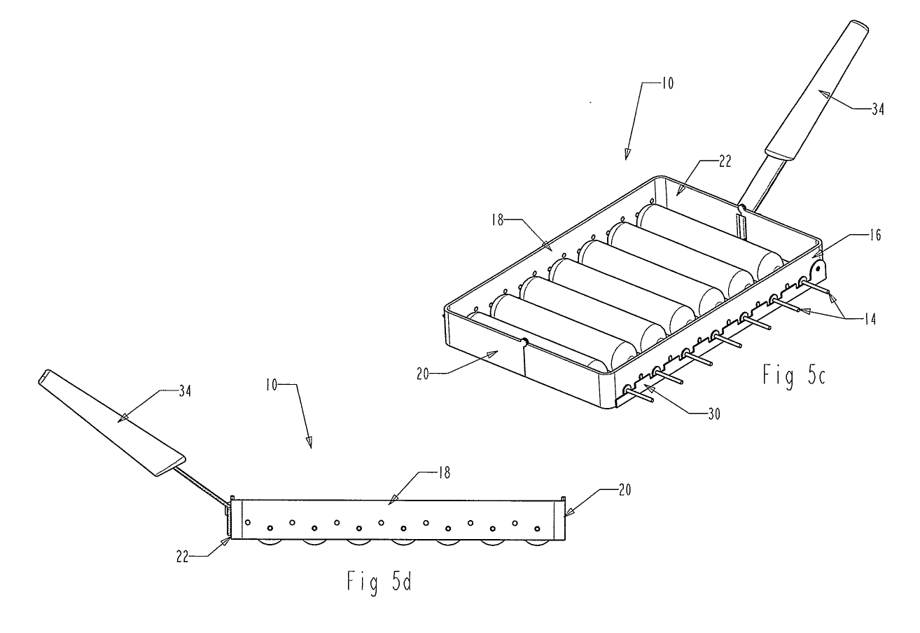

Each of the food supporting members 14 comprises a skewer 24 onto which one or more items of food can be supported. The food is supported by threading the skewer 24 through the approximate centre of the food as shown in FIGS. 5c and 5d. The skewers 24 are arranged parallel to each other and extend between the first and second sides 16 and 18 of the frame 12.

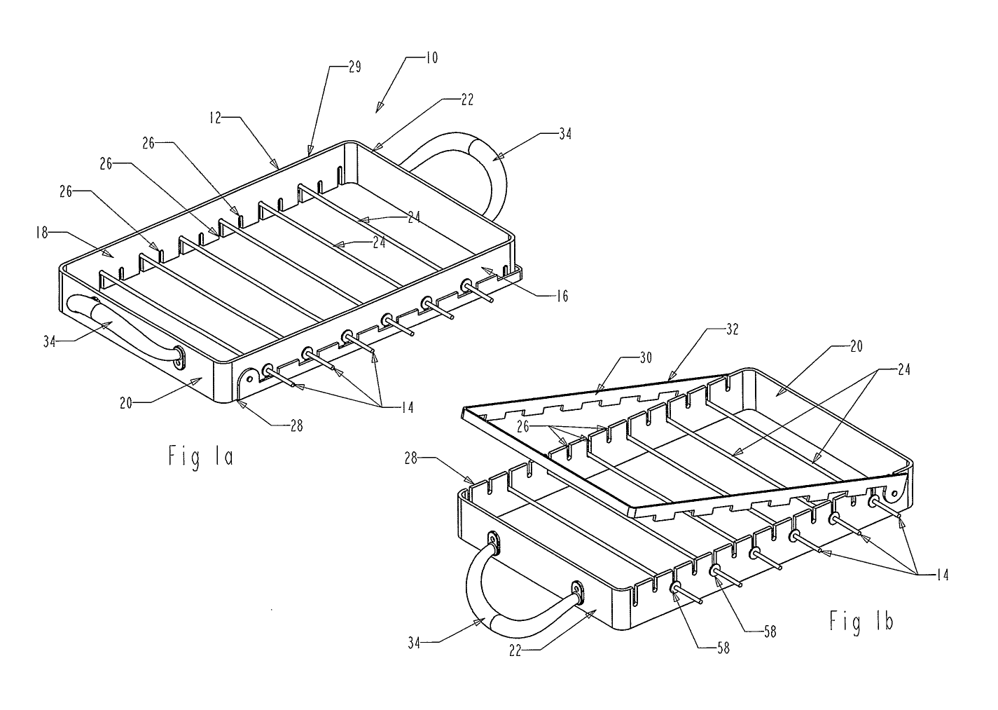

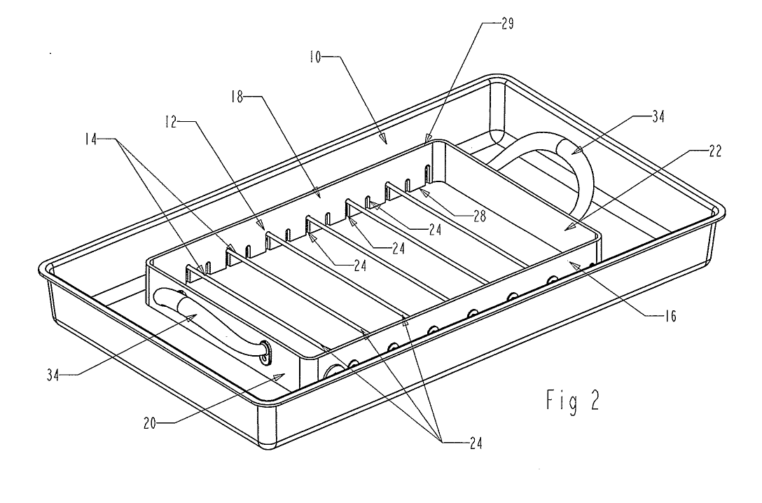

The skewers 24 are supported between the first and second sides 16 and 18 by any suitable means but are detachable from at least one of the first or second sides 16 or 18 so that food can be placed onto the skewers 24. In the embodiment shown in FIG. 1, each of the first and second sides 16 and 18 includes a plurality of slots 26 extending upwardly from the lower edge 28 of the frame 12. The lower edges 28 of the first and second side members 16 and 18 are the part of the food rack 10 closest to the cooking surface in use. The skewers 24 are placed in the slots 26 when the frame 12 is held upside down as shown in FIG. 1b.

The skewers 24 are then held in place by a securing member 30. The securing member 30 of FIG. 1 comprises a generally U-shaped member 32 wherein the dimensions of the U-shaped member 32 correspond approximately to the first and second sides 16 and 18 and the second end 22 of the frame 12. Ends of the U-shaped member are pivotally mounted to the first and second sides 16 and 18 adjacent the first end 20 of the frame.

The U-shaped member 32 is thereby pivotable between a position in which it rests across open ends of the slots 26, preventing removal of the skewers 24 (as shown in FIG. 1a) and a position in which the slots 26 are opened (as shown in FIG. 1b) allowing the skewers 24 to be placed in the slots 26.

Each of the skewers 24 also includes a widened portion 58 to rest adjacent the outside surface of the frame 12 adjacent the slot 26. The widened portions 58 in the embodiment shown comprise circular flanges constructed to be wider than the width of the slots 26. The widened portions 58 prevent the skewers 24 from sliding longitudinally relative to the frame 12. The widened portions 58 in the embodiment shown are provided only adjacent the outside surface of the frame 12, however a pair of widened portions 58 may be provided with one resting adjacent the outside of the frame 12 and one adjacent the inside of the frame 12, preventing longitudinal movement in either direction.

The lengths of the slots 26 are set such that when food items are placed on the skewers 24, for example sausages threaded centrally onto the skewers 24, the food items protrude beyond the lower edge 28 of the frame 12. The frame 12 may be provided with slots 26 of varying depth to allow for food items of different dimensions.

The skewers 24 are mounted in the slots 26 such that the skewers 24 are free to rotate about their longitudinal axis. In use, food threaded onto the skewers 24 comes into contact with the cooking surface when the food rack 10 is placed on the cooking surface. When the frame 12 is moved parallel to the cooking surface in the direction of the first or second ends 20 or 22, the contact of the food items with the cooking surface cause the food items and the skewers 24 to rotate within the frame 12. Therefore, movement of the frame 12 in this manner evenly turns all of the food items simultaneously.

Cooking of the food items evenly can therefore be effected by simply moving the frame 12 as required on the cooking surface.

Also, the same action can be used to rotate the food items for other purposes prior to or after cooking. For example, the food items may be rolled across paper towels after cooking to remove excess oil. The handles 34 extend outwardly from the first and/or second ends 20 and also upwardly away from the cooking surface in use.

The frame 12 is provided with one or more handles 34 mounted on the first and/or second ends 20 and/or 22 by which the user can move the frame 12.

When it is required to remove the food items from the skewers 24, the skewers can be pulled longitudinally outward from the frame 12. The food items will engage with the frame 12 allowing the skewers 24 to be pulled from the food items.

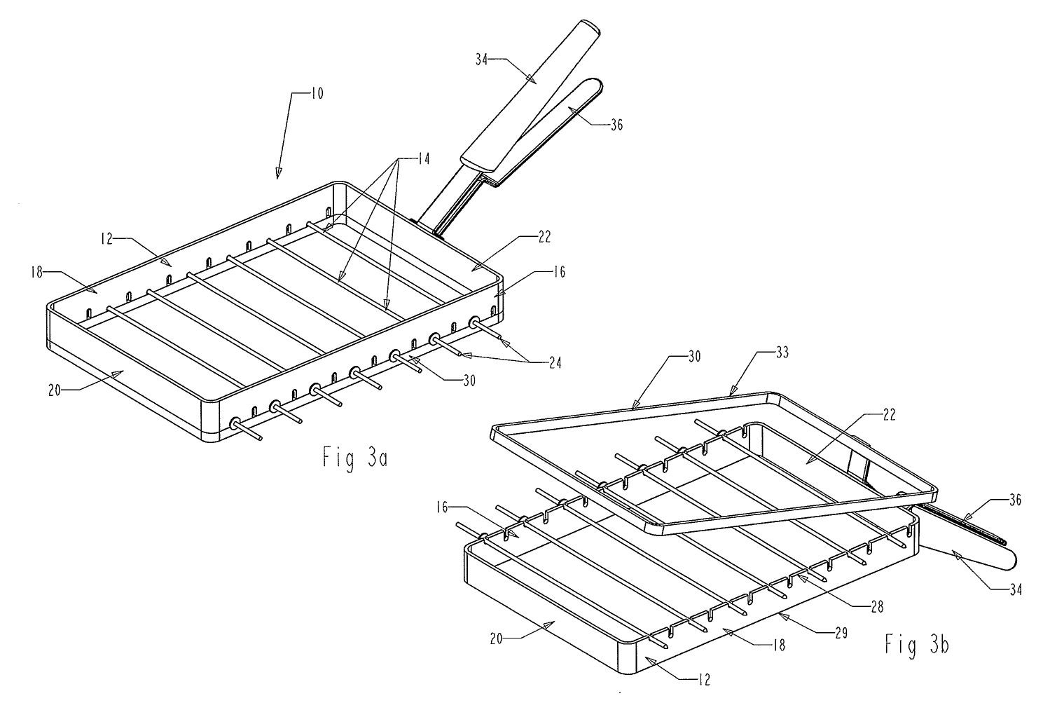

FIGS. 3a and 3b show an embodiment of a food rack 10 in which the securing member 30 is provided with a lever 36 such that movement of the lever 36 causes the pivotal movement of the securing member 30. The lever 36 is arranged parallel to and below the handle 34 such that the user can grip both the handle and the lever 36 at the same time such that compressing the handle 34 and the lever 36 together causes the securing member 30 to pivot to the open position. The securing member 30 in this embodiment comprises a rectangular member 33 instead of the U-shaped member 32.

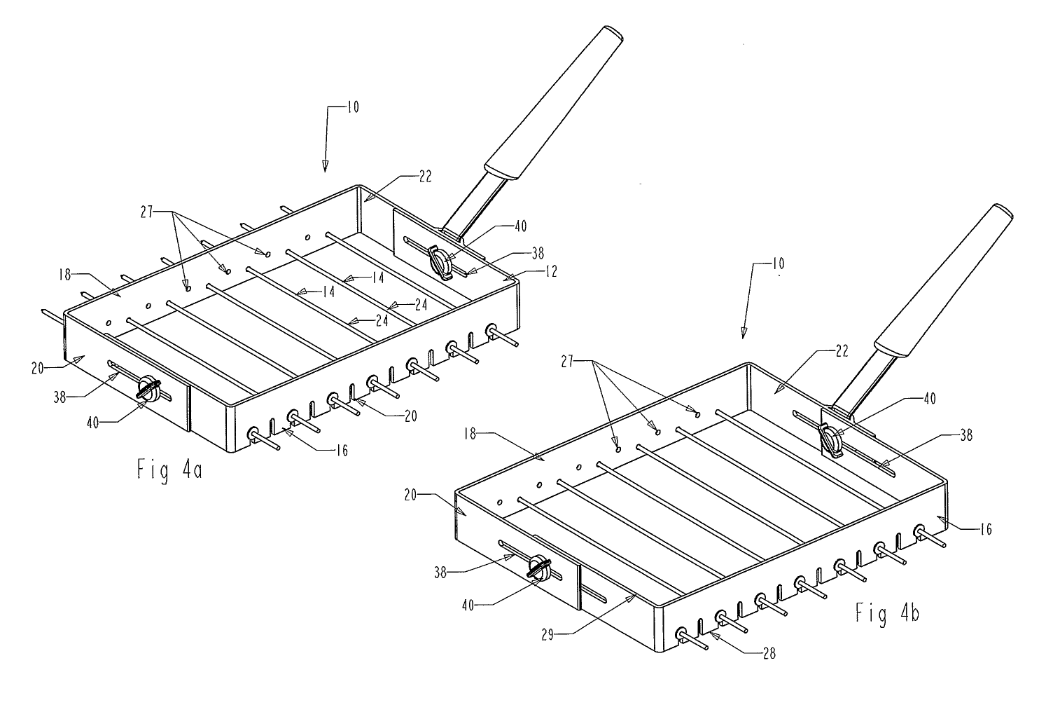

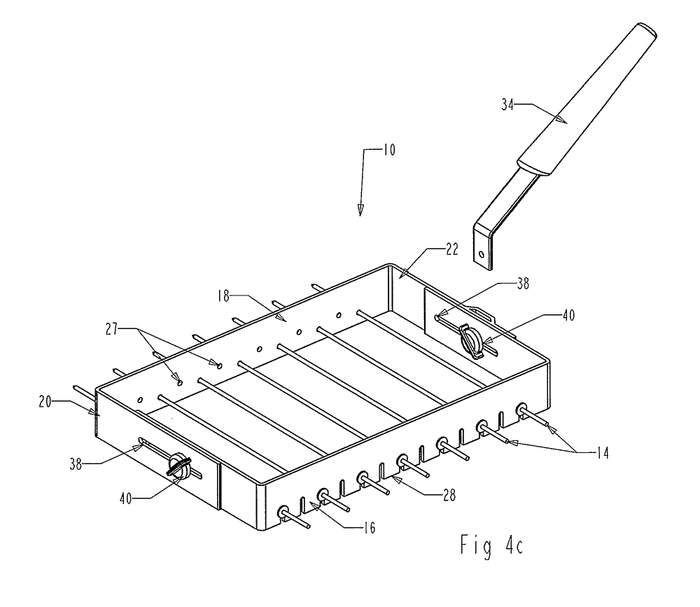

FIGS. 4a to 4c show an embodiment in which the first and second ends 20 and 22 each comprise two separate parts. The two parts of each of the first and second ends 20 and 22 are provided with a longitudinal slot 38. A fixing means 40 is provided for each of the first and second ends 20 and 22 such that the fixing means 40 is received through the slots 38 and can be tightened to secure the two parts of the first and second ends 20 and 22 to each other. In this way, loosening the fixing means 40 allows the first and second sides 16 and 18 to be moved either away from or toward each other, thus allowing food items of differing lengths to be accommodated. The handle 34 may also be secured to the frame 12 by one of the fixing means 40 such that the handle can be removed if required (as shown in FIG. 4c).

Also, in the embodiment of FIGS. 4a to 4c, the slots 26 on the second side 18 of the frame 12 are replaced by holes 27. It will be appreciated in this embodiment that the securing member 30 need not be U-shaped as it only is required to close off the slots 26 on the first side 16 of the frame 12.

FIGS. 5a and 5b show an embodiment of a food rack 10 in which the first and second ends 20 and 22 are again provided as two parts but the two parts are pivotally connected. The two parts are pivotally connected adjacent the upper edge 29 of the first and second ends 20 and 22 and are pivotable about each other in the plane of the plate members comprising the first and second ends 20 and 22. The first and second sides 16 and 18 can therefore be pivotally moved to a position in which the first side 16 rests on top of the second side 18 as shown in FIG. 5b for easier storage of the food rack 10.

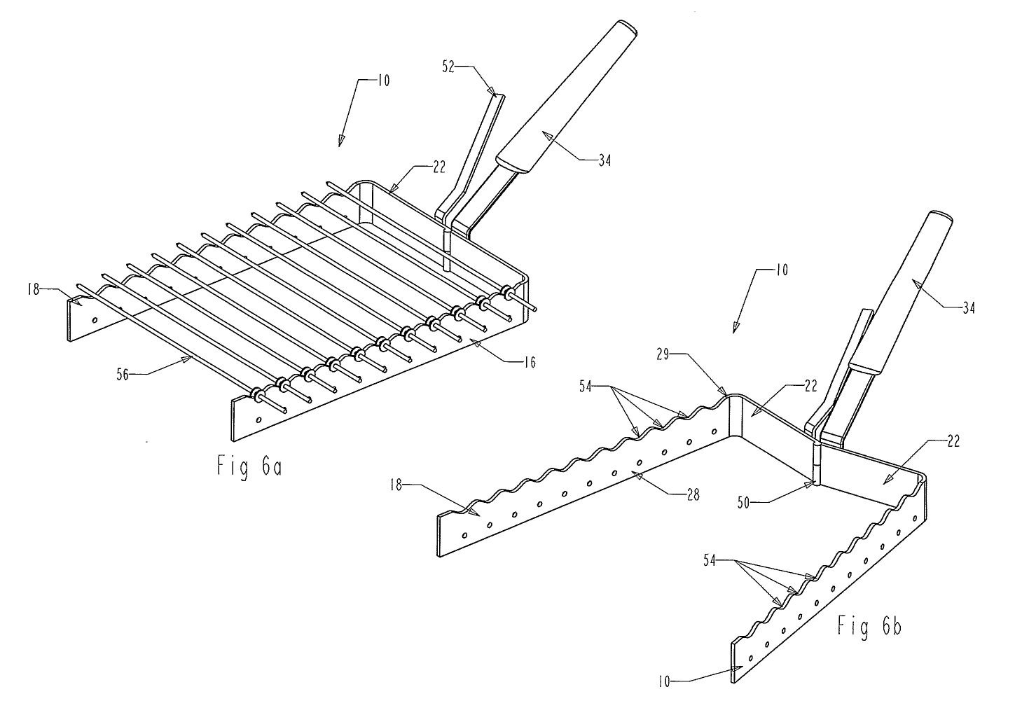

FIGS. 6a and 6b show an embodiment in which the second end 22 is provided in two pivotally connected parts and the first end 20 is open. The two pivotally connected parts of the second end 22 are connected by a hinge 50 such that they pivot about a vertical axis such that the first and second sides 16 and 18 can be angled with respect to each other as shown in FIG. 6b. The handle 34 is provided on a first side of the hinge 50, a lever 52 is provided on a second side of the hinge 50 and the hinge 50 is spring biased such that compressing the lever 52 towards the handle 34 compresses the spring and pivots the two parts of the first end 20, thereby moving the first and second sides 16 and 18 away from each other. The embodiment of FIG. 6 is provided with holes 27 on both the first and second sides 16 and 18 and the movement of the first and second sides 16 and 18 away from each other causes the skewers 24 to be released from the holes.

Further, the food rack 10 of FIG. 6 is also provided with corrugations 54 on an upper edge 29 of the frame 10. The corrugations 54 provide an additional feature of receiving a second set of skewers 56, resting in the corrugations 54 across from the first side 16 to the second side 18. The second set of skewers 56 may be used for placing and cooking food items that do not need to come into contact with the cooking surface.

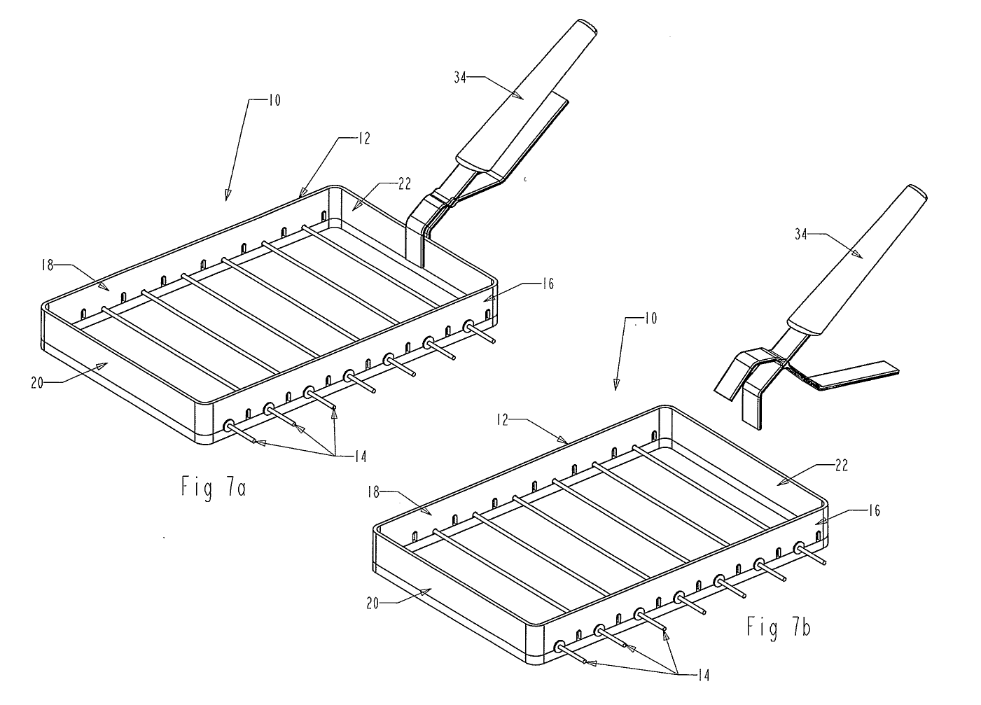

FIGS. 7a and 7b show a food rack in which the handle 34 is provided as a separate item. The handle 34 of FIGS. 7a and 7b is constructed of two pivotally connected members such that the handle functions in a manner similar to a set of pliers. Gripping and pressing together of ends of the pivotally connected members causes the other ends of the pivotally connected members to move together, which can then grip the frame for movement or lifting of the frame 12.

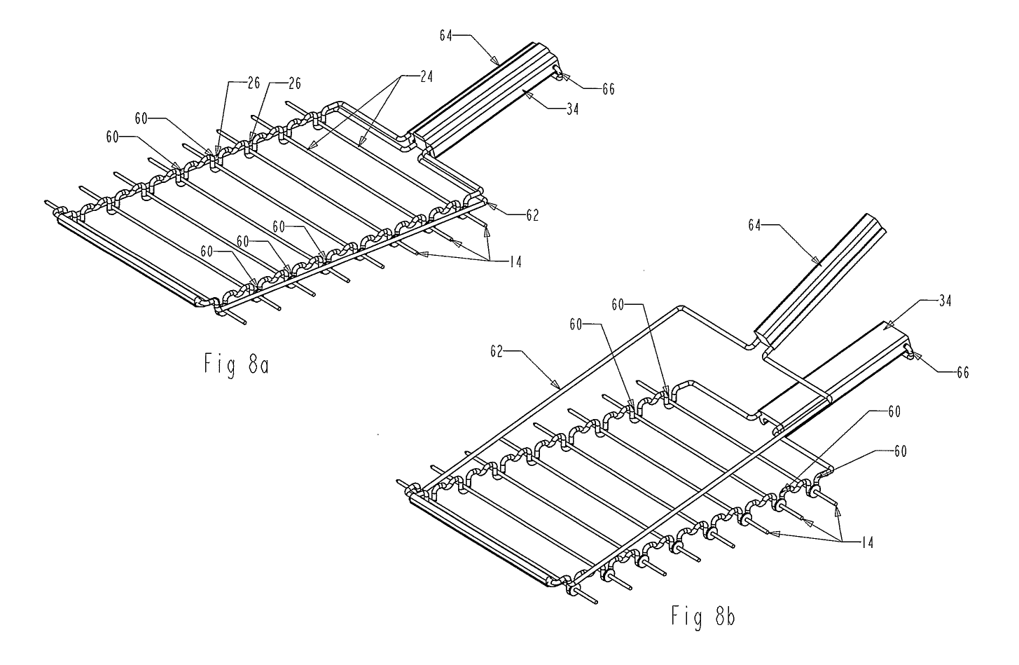

FIGS. 8a to 10b show embodiments of food racks 10 in which the first and second sides 16 and 18 and first and second ends 20 and 22 comprises elongate rod members rather than flat plate members. The frame 12 is therefore a rectangular wire frame constructions.

The slots 26 into which the skewers 24 are received comprise a first set of V-shaped bends 60 along the length of the first and second sides 16 and 18. The V-shaped bends 60 on the first and second sides 16 and 18 are open toward the upper edge of the frame 12 and the embodiments of FIGS. 8 to 10 therefore include a securing means 30 that seals across the slots 26 around the upper edge of the frame 12. The frame 12 also includes a second set of V-shaped bends 61 interspersed between the first set of V-shaped bends 60. The second set of V-shaped bends 61 perform the function of the corrugations 54 of FIG. 6.

In the embodiment shown in FIG. 8, the securing means 30 comprises a rectangular wire frame 62 that is mounted for pivotal movement about the first end 20 of the frame 12. The securing member 30 includes a securing member handle 64 adjacent the second side 22 of the frame such that when the securing member 30 is secured across the slots 26, the securing member handle 64 rests on top of the handle 34.

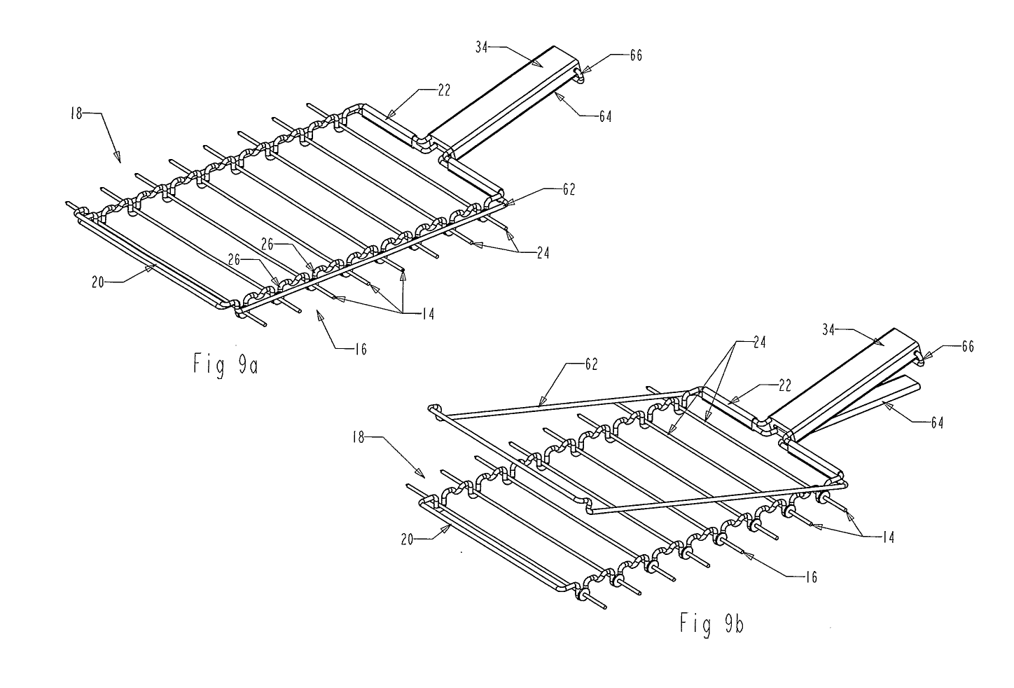

In the embodiment shown in FIG. 9, the securing member 30 also comprises a rectangular wire frame 62 that is mounted for pivotal movement about the second end 22 of the frame 12. The securing member 30 includes a securing member handle 64 adjacent the second side 22 of the frame mounted below the handle 34. The securing member handle 64 is arranged such that when the securing member 30 is secured across the slots 26, the securing member handle 64 rests below the handle 34 and pivoting the securing member handle 64 downwardly away from the handle 34 pivots the securing member 30 to the open position. The handle 34 is preferably provided with a recess on a lower surface thereof to receive the securing member handle 64.

The handle 34 may be provided with an opening (not shown) to allow access to the securing member handle 64 from above so that pressing the securing member handle 64 through the opening pushes the securing member handle 64 away from the handle 34. Alternatively, a spring may be mounted between the handle 34 and the securing member handle 64 to bias the securing member handle 64 to move away from the handle 34.

A locking member 66 is also provided adjacent the end of the handle 34 to lock the handle 34 to the securing member handle 64. The locking member 66 comprises a ring pivotally secured to the handle 34 that can be rotated to engage around the securing member handle 64.

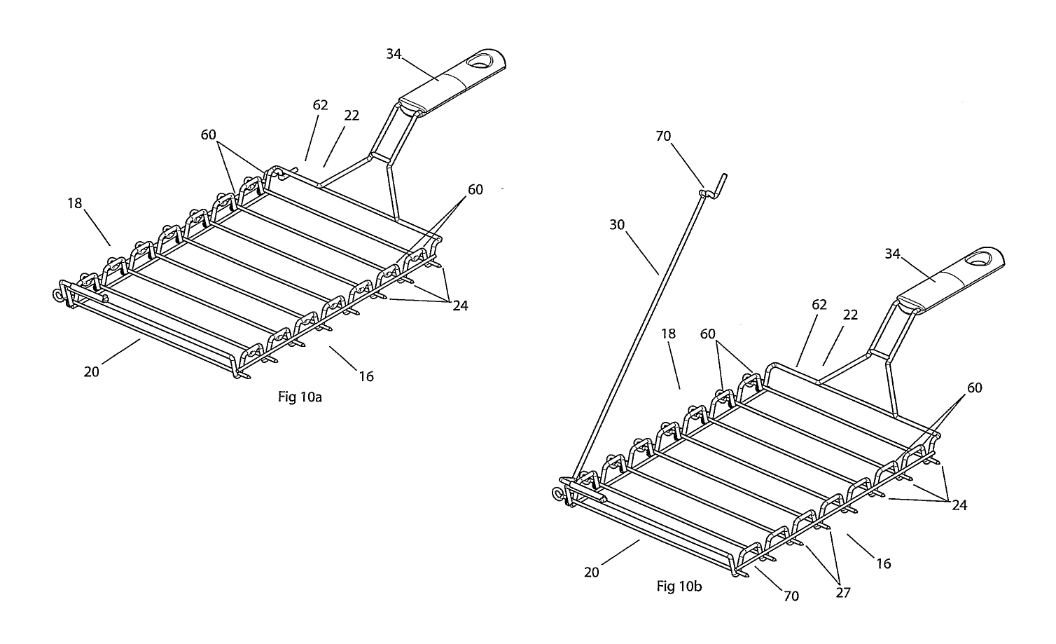

In the embodiment of FIG. 10, the first side 16 of the wire frame 62 is provided with an elongate member 70 that extends across each of the V-shaped bends 60. The elongate member 70 thereby creates holes 27 into which ends of the skewers 24 can be received. The securing member 30 therefore extends only along the second side 18 to close across the V-shaped bends 60 on the second side 18.

The securing member 30 is pivotally secured at a first end thereof to the first end 20 of the frame 12 adjacent the second side 18. A second end of the securing member 30 includes a catch 70 arranged to engage with the second end 22 of the frame adjacent the second side 18. The catch 70 comprises a first portion extending transversely from the securing member 30 parallel to the skewers 24 and a second portion extending from the first portion perpendicular to the plane of the frame 12. The securing member 30 is moved against the skewers 24 and flexed such that the catch 70 moves under the frame 12. On release, the first portion of the catch 70 engages with the frame 12 and the second portion extends upwardly within the frame to prevent disengagement of the catch 70 from the frame 12.

Modifications and variations as would be apparent to a skilled addressee are deemed to be within the scope of the present invention.

1. A food rack comprising:
a frame having a plurality of food supporting members mounted rotatably within the frame, at least one end of the food supporting members being detachable from the frame to allow the food supporting members to be passed through food items; wherein when the food items are supported on the food supporting members and the frame is placed over a cooking surface, each of the food items contacts a cooking surface and movement of the frame parallel to the cooking surface causes rotation of the food supporting members.

2. A food rack in accordance with claim 1, wherein the frame includes first and second side members and the food supporting members comprise a plurality of parallel skewers extending between first and second side members adjacent lower edges thereof, the lower edges being the part of the food rack closest to the cooking surface in use.

3. A food rack in accordance with claim 1, wherein the frame includes a handle extending both away from the frame and the lower edges of the first and second side members.

4. A food rack in accordance with claim 1, wherein the frame is provided with a securing member moveable between a closed position in which the securing member prevents movement of the food supporting members away from the frame and an open position in which at least an end of the food supporting member is detachable from the frame.

5. A food rack in accordance with claim 4, wherein the securing member is pivotally secured adjacent an end of the first and second side members such that the securing member is pivotable between the open and closed positions thereof.

6. A food rack in accordance with claim 5, wherein the first and second side members each include slots extending upwardly from the lower edges thereof into which are received the ends of the food supporting members and the securing member comprises a U-shaped member pivotable such that sides of the U-shaped member close across the slots to retain the food supporting members in the slots.

7. A food rack in accordance with claim 5, wherein the first side member includes slots extending upwardly from the lower edge thereof for receiving ad ends of the food supporting members, the second side member includes a plurality of holes adjacent the lower edge thereof for receiving ends of the food supporting members and the securing member comprises a member pivotable such that securing member closes across the slots in the first side member to retain the food supporting members.

8. A food rack in accordance with claim 4, wherein the securing member is provided with a lever wherein actuation of the lever moves the securing member from the closed to the open position.

9. A food rack in accordance with claim 8, wherein the lever is located adjacent the handle such that gripping the handle and lever together moves the securing member to the open position.

10. A food rack in accordance with claim 2, wherein the first and second side members are joined by first and second end members, the first end member extending between first ends of the first and second side members and the second end member extending between second ends of the first and second side members.

11. A food rack in accordance with claim 10 wherein each of the first and second side members and the first and second end member comprise an elongate plate member oriented in a vertical plane.

12. A food rack in accordance with claim 10, wherein the lengths of the first and second end members are adjustable such that the first and second side members may be moved either toward each other or away from each other to accommodate different sized food items.

13. A food rack in accordance with claim 10, wherein each of the first and second side members includes holes to receive the food supporting members and the first end member comprises first and second parts pivotally connected such that pivoting of the first and second parts causes the second ends of the first and second side members to move away from each other, thereby allowing the food supporting members to disengage from the holes.

14. A food rack in accordance with claim 10, wherein the first end member comprises first and second parts pivotally connected such that pivoting of the first and second parts relative to each other allows the first end member to be moved to a position on top of the second side member for storage.

15. A food rack in accordance with claim 13, wherein the handle is detachable from the frame.

16. A food rack in accordance with claim 6, wherein the first and second side members comprise elongate rod members having a first set of V-shaped bends extending upwardly from the lower edge in which are received the food supporting members.

17. A food rack in accordance with claim 2, wherein the first and second side members are provided with corrugations on an upper edge thereof for receiving a second set of food supporting members for cooking food items that do not require to be in contact with the cooking surface.

18. A food rack comprising:
a frame having a plurality of food supporting members mounted on opposite sides of the frame, wherein at least one end of each of the food supporting members is detachable one of the sides of the frame to allow food items to slide onto the end and to be supported by the food supporting member;
the opposite sides each have a lower edge facing a cooking surface when the food rack with food items is placed on the cooking surface to cook the food, and
a distance between the lower edges and the food supporting members when mounted on the opposite sides of the frame is less than one-half an average thickness of the food items slid onto the ends of the food supporting members.

19. The food rack of claim 18, wherein the food supporting members comprise a plurality of parallel skewers extending between the opposite side members.

20. A method of cooking using a food rack including a frame including parallel skewers mounted to opposite sides of the frame wherein the skewers are proximate to lower edges of the opposite sides and extend between the opposite sides, the method comprising:
releasing at least one end of the skewers from one of the sides of the frame;
sliding food items onto the released skewers;
attaching the released ends of the skewers to the side of the frame;
placing the food rack with the food items on the skewers on a heated cooking surface wherein the food items contact the cooking surface and the lower edges of the opposite sides face the cooking surface;
moving the food rack with the food items on the skewers over the cooking surface in a direction generally perpendicular to skewers, wherein the food items rotate due to the movement of the food rack and the contact between the food items and the cooking surface.
